(19) United States
(12) Patent Application Publication
(10) Pub. No.: US 2007/0100474 A1
(43) Pub. Date: May 3, 2007

(54) Fan controlling system to control fans according to categories to which heating members belong and related method

(75) Inventors: Chun Liang Lee, Taipei (TW); Ji Chi Yang, Taiwan (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/264,764

(22) Filed: Oct. 31, 2005

(51) Int. Cl. G05B 11/01

(52) U.S. Cl. 700/25

(57) ABSTRACT

A fan controlling system and method are used to control a fan provided to dissipate heat produced by a heating member. The fan controlling method includes providing a database for storing categories to which a plurality of heating members respectively belong and corresponding fan operating parameters, detecting a category to which the heating member belongs, selecting one of the fan operating parameters stored in the database according to the detected category, and controlling the fan according to the selected fan operating parameter, thereby achieving a preferable heat dissipating effect.

### BACKGROUND OF THE INVENTION

1. Field of the Invention

The present invention relates to a fan controlling technique, and more particularly, to a fan controlling system and method to control a fan to dissipate heat produced by a heating member according to a category to which the heating member belongs.

2. Description of Related Art

As a core component of a computer, a central processing unit (CPU) operating at high frequency produces a lot of heat, which accordingly increases the temperature of the CPU. To stabilize calculating capability of the CPU and prevent the CPU from being damaged due to high temperature, cooling measures need to be taken.

In early days, a heat sink structure or heat sink compound was usually used for dissipating heat generated by a CPU. Later, a fan structure is prosed for improving heat dissipating efficiency. Now, with development of technologies, operating frequency of a CPU could reach as high as 100 GHz or even higher. Meanwhile, electronic circuits of a CPU with high precision are arranged in a much smaller area. For example, hundreds of thousands of logic operators could be arranged in an area of three to four square centimeter. A CPU could comprise millions of logic operators if the logic operators are arranged in several layers. As a CPU increases in operating frequency, the generated heat increases. As CPU decreases in area, the generated heat is confined to a smaller space. As a result, more heat is confined to a much smaller space, thereby affecting the heats dissipating efficiency. Accordingly, a more efficient heating structure including a fan and a heat sink has been proposed and become the mainstream, as shown in FIG. 1. A heat sink 11 is mounted on a CPU 10. The heat sink 11 could be made of metal having good thermal conductivity such as copper or aluminum. The heat sink 11 is provided with a fin structure such that heat generated by the CPU 10 could be guided to an upper surface of the heat sink 11. On the heat sink 11, a fan 12 is further disposed to dissipate the generated heat to a region outside of a computer casing through heat dissipating holes (not shown) installed on the computer casing.

If a CPU is operating at full load, because of its high executing speed capability, the temperature could rise sharply, for example, rise to 100 degrees centigrade. As a result, the fan rotating speed should be increased timely to enhance the heat dissipating efficiency. On the other hand, if a fan operates at a high speed all the time, a large amount of electrical energy will be consumed and the operating life of the fan will be decreased. In addition, the fan noise is so high that user satisfaction is decreased. Therefore, it is preferable that the fan rotating speed could be decreased when the CPU does not work at full load or the CPU has a low temperature. Thus, a fan controlling method is proposed which can change the fan rotating speed according to the temperature of a CPU. Therein, a temperature sensor is used to detect the temperature of the CPU, then, the detected temperature is compared with a preset fan operating table such that the fan could be operated corresponding to a suitable operating status.

However, in the above mentioned method, the fan control table is only suitable to a certain type or a certain series of CPUs. For example, Athlon 64, Athlon 64 Fx and Athlon Opteron of the Supermicro, Inc. respectively have different fan control tables. If the fan control table of a computer system doesn't match the category of the CPU, the fan control mistakes are liable to occur, for example, the fan rotating speed is not decreased or increased when needed, bringing inconvenience or trouble to manufactures and users.

In view of the above defects, there is a need to develop a fan controlling technique that can be applied to different categories of heating members (such as CPUs).

### SUMMARY OF INVENTION.

According to the above defects, a primary objective of the present invention is to provide a fan controlling system and method which can provide a general fan controlling technique for different categories of heating members.

Another objective of the present invention is to provide a fan controlling system and method which can facilitate the fan control and enhance the fan operating efficiency.

To achieve the above and other objectives, the present invention provides a fan controlling system and method. The fan controlling system is used to control a fan provided to dissipate heat produced by a heating member. The fan controlling system includes a database for storing categories to which a plurality of heating members respectively belong and corresponding fan operating parameters, a detecting module for detecting a category to which the heating member belong, a selecting module for selecting one of the fan operating parameters stored in the database according to the detected category detected by the detecting module, and a controlling module for controlling the fan according to the selected fan operating parameter selected by the selecting module. The heating member is a central processing unit (CPU) and the selecting module is a baseboard management controller BMC).

The fan controlling method is used to control a fan provided to dissipate heat produced by a heating member. The fan controlling method includes providing a database for storing categories to which a plurality of heating members respectively belong and corresponding fan operating perimeters, detecting a category to which the heating member belongs, selecting one of the fan operating parameters stored in the database according to the detected category, controlling the fan according to the selected fan operating parameter.

Compared with the prior art that needs to provide different fans for different heating members, the fan controlling system and method of the present invention makes it possible to provide a general fan for different categories of heating members such as CPUs, thereby facilitating the fan control, enhancing the fan operating efficiency and reducing cost.

### BRIEF DESCRIPTION OF DRAWINGS

FIG. 1 is a perspective view of a combined structure of a central processing unit (CPU), a heat sink and a fan;

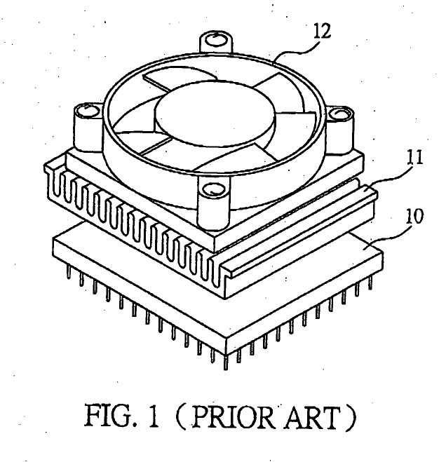

FIG. 2 is a functional block diagram of a fan controlling system according to the present invention; and

FIG. 3 is a flow chart of a fan controlling method according to the present invention.

### DETAILED DESCRIPTION OF PORED EMBODIMENT

Hereunder, embodiments of the present invention will be described in full detail with reference to the accompanying drawings.

The disclosure describes a fan controlling system which is used to control a fan provided to dissipate heat produced by a heating member, such as a central processing unit (CPU).

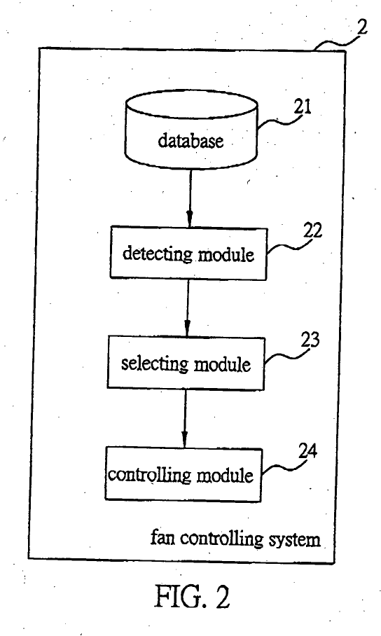

Referring to FIG. 2, a fan controlling system 2 of the present invention comprises a database 21 for storing categories to which a plurality of heating members respectively belong and corresponding fan operating parameters, a detecting module 22 for detecting a category to which the heating member belongs, a selecting module 23 for selecting one of the fan operating parameters stored in the database 21 according to the detected category detected by the detecting module 22, and a controlling module 24 for controlling the fan according to the selected fan operating parameter selected by the selecting module 23.

In general, CPUs of different categories (different types or different series) have different temperature calculating methods, and different temperature values correspond to different fan operating parameters. For example, Athlon 64, Athlon 64 FX and Athion Opteron produced by Advanced Micro Device (AMD) are respectively provided with different temperature calculating methods and different temperature values correspond to different fan operating parameters. As a result, the fan operating parameters stored in the database 21 correspond to a variety of fan rotating speeds of CPUs of different categories. In the present embodiment, the fan operating parameters refer to the fan rotating speeds. The fan operating parameters corresponding to categories of CPUs are stored in the database 21 in the form of a control table, which records fan rotating speeds corresponding to different temperature thresholds. For example, when the temperature of a CPU rises above 80 degrees centigrade, the fan rotating speed is 6000 revolutions per minute (RPM); when the temperature of the CPU does not exceed 30 degrees centigrade, the fan rotating speed is 2000 revolutions per minute (RPM). Therefore, the control table listing of a plurality of fan rotating speed is created according to different categories of CPUs for the fan controlling system 2 to control the fan rotating speed. For example, when the temperature of a CPU exceeds a high temperature threshold, the fan rotating speed will be increased according to the fan operating parameter (fan rotating speed) recorded in the control table; on the other hand, when the temperature of the CPU is below a low temperature threshold, the fan rotating speed will be decreased according to the fan operating parameter.

In the present embodiment, the detecting module 22 is a basic input output system (BIOS) installed on a computer motherboard and is installed to detect the category of the CPU after the computer is powered on. Ordinarily, the BIOS automatically detects the category of the CPU after the computer is powered on. Since the detecting process is a prior art, its detailed description is omitted.

In the present embodiment, the selecting module 23 is a baseboard management controller (BMC) of the computer and has independent processing capabilities, which are used to monitor and manage the temperature and voltage inside the computer as well as operating statuses of the fan. Since the principle and application of the BMC is a prior art, detailed description of it is omitted.

As mention above, the fan operating parameters are stored in the control table, which is used to record a plurality of temperature thresholds and corresponding fan rotating speeds according to different categories of CPUs. That is, when the temperature of a CPU is higher than a certain threshold, the controlling module 24 increases the fan rotating speed to increase heat dissipating efficiency, on the other hand, when the temperature of the CPU is below a certain threshold, the controlling module 24 decreases the fan rotating speed to reduce noises made by the rotating fan and save electrical energy, thereby increasing an operating life of the fan.

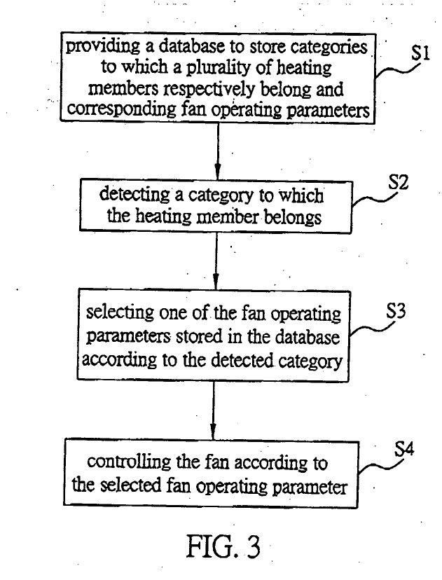

FIG. 3 shows a flow chart of a fan controlling method according to the present invention. The fan controlling method controls a fan through the fan controlling system 2 such that heat produced by CPUs of different categories are able to be dissipated a single fan. Please refer to FIG. 3 as well as Fig. 2. The fan controlling method begins in step S1. In step S1, a database 21 is provided to store categories to which a plurality of CPUs respectively belong and corresponding fan operating parameters. The fan operating parameters refer to the fan rotating speeds corresponding to the categories of CPUs and are saved in the database 21 in the form of a control table.

In step S2, the detecting module 22 detects a category to which a CPU belongs. In the present embodiment, the detecting module 22 detects the category of the CPU with a detecting program of the BIOS when the computer is powered on.

In step S3, the selecting module 23 selects one of the fan operating parameters stored in the database 21 according to the detected category of the CPU detected by the detecting module 22.

In step S4, the controlling module 24 controls the fan according to the selected fan operating parameter selected by the selecting module 23.

Compared with the prior art that needs to provide different fans for different heating members, the fan controlling system and method of the present invention makes it possible to use a general fan for diffident categories of heating members (such as CPUs). The present invention controls the fan rotating speed according to the selected operating parameters such that the system shutdown is not liable to happen and the CPU is got easy to be damaged due to too high temperature of the CPU, and the fan noise could be reduced and the electrical energy could be saved by reducing the fan rotating speed when the temperature of the CPU is not high.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A fan controlling system used to control a fan provided to dissipate heat produced by
a heating member, the fan controlling system comprising:
a database for storing categories to which a plurality of heating members respectively belong and corresponding fan operating parameters;
a detecting module for detecting a category to which the heating member belongs;
a selecting module for selecting one of the fan operating parameters stored in the database according to the detected category detected by the detecting module; and
a controlling module for controlling the fan according to the selected fan operating parameter selected by the selecting module.

2. The fan controlling system of claim 1, wherein the fan operating parameters are stored in the database in the form of a control table.

3. The fan controlling system of claim 1, wherein the selected fan operating parameter refers to a fan rotating speed corresponding to the detected category to which the heating member belongs.

4. The fan controlling system of claim 1, wherein the detecting module is a basic input output system (BIOS) installed on a computer motherboard.

5. The fan controlling system of claim 1, wherein the selecting module is a baseboard management controller (BMC).

6. A fan controlling method used to control a fan provided to dissipate heat produced by a heating member, the fan controlling method comprising:
providing a database for storing categories to which a plurality of heating members respectively belong and corresponding fan operating parameters;
detecting a category to which the heating member belongs;
Selecting one of the fan operating parameters stored in the database according to the detected category; and
controlling the fan according to the selected fan operating parameter.

7. The fan controlling method of claim 1, wherein the fan operating parameters are stored in the database is the form of a control table.

8. The fan controlling method of claim 1, wherein the selected fan operating parameter refers to a fan rotating speed corresponding to the detected category to which the heating member belongs.
